(19) United States
(12) Patent Application Publication
(10) Pub. No.: US 2016/0349769 A1
(43) Pub. Date: Dec. 1, 2016

(54) MANAGEMENT SYSTEM FOR VINYL GREENHOUSE AND METHOD FOR PROCESSING THEREOF

(71) Applicant: ARAM Solution Co., Ltd., Jeonju (KR)

(72) Inventor: JUN LEE, Jeonju (KR)

(21) Appl. No.: 14/791,560

(22) Filed: Jul. 6, 2015

(30) Foreign Application Priority Data
May 26, 2015 (KR) 10-2015-0073119

(51) Int. Cl. G05D 23/13; H04L 29/08

(52) U.S. Cl. CPC G05D 23/1393; H04L 67/12

(57) ABSTRACT

The present invention relates to a vinyl greenhouse management system and a processing method thereof. The vinyl greenhouse management system of the present invention includes a plurality of sensor terminals provided at a vinyl greenhouse, a control device configured to receive various sensed information about an environmental condition of the vinyl greenhouse from the sensor terminals so as to control a status of the vinyl greenhouse, a vinyl greenhouse management server connected with the control device and configured to collect the sensed information, and a user terminal and a manager terminal configured to monitor or remote control the status of the vinyl greenhouse as being linked with the vinyl greenhouse management server. The vinyl greenhouse includes a heating film on a partial surface of a structure. In the heating film, a plurality of heating patterns and a plurality of circuit patterns are formed of conductive ink on a surface of a polymer film by using the printed electronics. The sensor terminals are electrically connected with the control device through the circuit patterns so as to transfer the sensed information. In response to the sensed information of the vinyl greenhouse, power supply from the control device to the heating patterns may be performed or stopped. According to the present invention, the heating film can be mass-produced at a low cost, and a status of the vinyl greenhouse can be monitored and remotely controlled in real time.

### BACKGROUND OF THE INVENTION

1. Field of the Invention

The present invention relates to a vinyl greenhouse management system, and more particularly, to a vinyl greenhouse management system which is configured to build a vinyl greenhouse with a heating film including a heating pattern and a circuit pattern formed by using the printed electronics, includes a plurality of sensor terminals configured to sense environmental conditions including a weight of snow accumulated on the vinyl greenhouse, a temperature and a wind speed around the vinyl greenhouse, an internal brightness of the vinyl greenhouse, and the like in real time, connects the sensor terminals to a control device with the circuit pattern of the heating film, monitors a status of the vinyl greenhouse through a user terminal and a manager terminal in real time by comparing sensed information supplied from the sensor terminals with predetermined reference information, and remotely controls power supply to the heating film, and a processing method thereof.

2. Description of the Related Art

Generally, a vinyl greenhouse is a form of temporary building constructed to be able to grow crops such as various kinds of vegetables all year around. Since the vinyl greenhouse is improved in productivity of crops and usability, a large number of vinyl greenhouses have been built all over the country. Generally, such a vinyl greenhouse is built by manufacturing a frame using materials such as iron bent so as to have a predetermined radius of curvature, synthetic resins and wood, installing the frame on the ground, and covering the installed frame with vinyl or a heat reserving material having a heat reserving function so as to isolate the inside from the outside and maintain a uniform internal temperature.

However, the vinyl greenhouse has a low durability or bearing capacity due to its simple structure. Thus, in the case of a rainstorm or heavy snow, the vinyl greenhouse is often damaged or collapsed. Particularly, in the case of heavy snow, the vinyl greenhouse is collapsed under a weight of snow deposited thereon, which causes considerable property damage. Further, when lots of snow are accumulated, even if the vinyl greenhouse is not collapsed, the snow blocks sunlight and has a bad influence on the growth of crops and thus may cause a reduction in the productivity of crops. In order to compensate such as defect, various apparatuses for removing snow from the vinyl greenhouse have already been disclosed.

For example, there has been disclosed a system configured to prevent collapse of a vinyl greenhouse by providing a heating sheet including a hot wire that generates heat at an upper part of the vinyl greenhouse so as to melt snow accumulated on the vinyl greenhouse. In the system, a heating pattern formed on the heating sheet is manufactured by patterning a conductive material on a sheet through a photolithography process or coating a conductive material on the entire surface of a sheet through a coating process. Such a process requires a high cost, and the heating sheet including a sheet heating pattern is added to vinyl of the vinyl greenhouse. Thus, a weight of the upper part of the vinyl greenhouse may be increased or sunlight needed for crops may be blocked.

### PRIOR ART DOCUMENT

(Patent Document 1) Korean Patent Laid-open Publication No. 10-2014-0125082 (published on Oct. 28, 2014)
(Patent Document 2) Korean Patent Laid-open Publication No. 10-2012-0120689 (published on Nov. 2, 2012)
(Patent Document 3) Korean Patent Publication No. 10-1112057 (published on Feb. 15, 2012)
(Patent Document 4) Korean Patent Publication No. 10-1469650 (published on Dec. 5, 2014)

### SUMMARY OF THE INVENTION

An object of the present invention is to provide a vinyl greenhouse management system including a plurality of sensor terminals through which various sensed information about an environmental condition of a vinyl greenhouse was measured to monitor a status of the vinyl greenhouse in real time and remotely control power supply, and a processing method thereof.

Another object of the present invention is to provide a vinyl greenhouse management system including a plurality of sensor terminals and a heating film configured to electrically connect a sensor terminal of a vinyl greenhouse including a control device with the control device using the printed electronics, and a processing method thereof.

Yet another object of the present invention is to provide a vinyl greenhouse management system configured to measure various sensed information about an environmental condition of a vinyl greenhouse and control power supply to a heating film in real time, and a processing method thereof.

In order to achieve the above-described objects, a vinyl greenhouse management system of the present invention is configured to build a vinyl greenhouse with a heating film including a heating pattern and a circuit pattern with a data transfer line formed by using the printed electronics and includes a plurality of sensor terminals configured to sense environmental conditions of the vinyl greenhouse in real time. The vinyl greenhouse management system of the present invention uses the printed electronics for forming the circuit pattern of the heating film by using conductive ink in order to transfer sensed information from the plurality of sensor terminals and thus electrically connects the sensor terminals with a control device. Therefore, it is possible to mass-produce the heating film at low cost and automatically operate the heating film by sensing a status of the vinyl greenhouse in real time, and it is possible for a user or a manager to remotely control the control device of the vinyl greenhouse.

According to the above-described aspect of the present invention, a vinyl greenhouse management system includes a heating film formed by printing conductive ink on a polymer film into a circuit patterns including a plurality of heating patterns and a plurality of data transfer lines by using the printed electronics and provided at a part of vinyl of a vinyl greenhouse; a plurality of sensor terminals respectively fixed and provided at different positions on a frame of the vinyl greenhouse and electrically connected with the data transfer lines of the heating film so as to measure various sensed information about an environmental condition of the vinyl greenhouse; a control device configured to receive the sensed information measured by the sensor terminals through the data transfer lines and compare the sensed information with predetermined reference information and control a power to be supplied to the heating pattern when the sensed information is out of a predetermined range; a vinyl greenhouse management server connected to the control device through a communication network and configured to collect the sensed information from the control device and correct and analyze the sensed information; and a user terminal configured to receive the sensed information corrected and analyzed by the vinyl greenhouse management server through the communication network and monitor and remotely control a status of the vinyl greenhouse in real time.

In an embodiment, the sensor terminal includes: a sensor unit including a sensor configured to measure at least one of a weight of snow accumulated on the vinyl greenhouse, a temperature around the vinyl greenhouse, an air volume around the vinyl greenhouse, and an amount of light within the vinyl greenhouse; a first storage unit configured to store the sensed information corresponding to the sensor; a first communication unit connected with the data transfer lines and configured to transfer the sensed information to the control device; and a first control unit configured to control the sensor unit, the first storage unit, and the first communication unit.

In another embodiment, the control device includes: a second storage unit configured to store the reference information about each of a weight of accumulated snow, an ambient temperature, an ambient air volume, and an internal brightness about an environmental condition of the vinyl greenhouse and the sensed information measured by the sensor terminals in real time; a power supply unit configured to supply a power of the control device and supply a power to the heating patterns of the heating film; a second communication unit configured to receive the sensed information from the sensor terminals and transfer the sensed information to the vinyl greenhouse management server; and a second control unit configured to control the second storage unit, the power supply unit, and the second communication unit and compare the sensed information with the reference information so as to supply power or stop supplying power from the power supply unit to the heating patterns.

In yet another embodiment, the vinyl greenhouse management server includes: a third communication unit provided to enable mutual data communication between the control device and the user terminal through the communication network; a third storage unit interconnected with the control device and the user terminal through the communication network and configured to store a vinyl greenhouse management program for monitoring the status of the vinyl greenhouse in real time and remotely control the power supply to the heating patterns; a database configured to store at least collected data corresponding to the sensed information and analyzed data generated by analyzing the collected data; and a third control unit configured to control the third communication unit, the third storage unit, and the database, supply the collected data and the analyzed data to the user terminal through the communication network, and, when remote control information is generated from the user terminal, transfer the remote control information to the control device to implement the vinyl greenhouse management program.

According to another aspect of the present invention, there is provided a processing method of a vinyl greenhouse management system that enables a user terminal to monitor a status of a vinyl greenhouse in real time and remotely control power supply to heating patterns through a communication network.

According to the above-described aspect of the present invention, a processing method of a vinyl greenhouse management system includes: providing a heating film formed by printing conductive ink on a polymer film into a circuit pattern including a plurality of heating patterns and a plurality of data transfer lines by using the printed electronics at a part of vinyl of a vinyl greenhouse, electrically connecting a plurality of sensor terminals respectively fixed and provided at different positions on the vinyl greenhouse and configured to measure various sensed information about an environmental condition of the vinyl greenhouse with the data transfer lines of the heating film, and comparing the sensed information with predetermined reference information corresponding to the sensed information so as to monitor a status of the vinyl greenhouse and remotely control power supply to the heating film through a user terminal; and supplying power or stopping supplying power to the heating patterns of the heating film according to a result of the comparison between the sensed information and the reference information.

In an embodiment, the processing method further includes: correcting and analyzing the sensed information so as to enable the user terminal to determine whether or not a remote control is needed while monitoring the status of the vinyl greenhouse and resetting the reference information according to the result of the determination.

As described above, according to the present invention, the vinyl greenhouse management system uses the printed electronics for forming the circuit pattern of the heating film by using conductive ink in order to transfer sensed information from the plurality of sensor terminals and thus electrically connects the sensor terminals with the control device. Therefore, it is possible to mass-produce the heating film at low cost and automatically operate the heating film by sensing a status of the vinyl greenhouse in real time.

Further, according to the vinyl greenhouse management system of the present invention, the heating film can be formed by using the printed electronics through a relatively simple process at a lower cost as compared with the photolithography process. Since only a necessary part can be printed with the conductive ink, it is possible to minimize unnecessary blocking of sunlight required for the growth of crops cultured in the vinyl greenhouse. Further, it is possible to easily manufacture a large-scale vinyl greenhouse and also possible to reduce a manufacturing cost.

Furthermore, since the vinyl greenhouse management system of the present invention supplies various sensed information about an environmental condition of the vinyl greenhouse in real time through the sensor terminals, it is possible for a user or a manager to monitor the vinyl greenhouse in real time and remotely control a status of the vinyl greenhouse.

### BRIEF DESCRIPTION OF THE DRAWINGS

FIG. 1 is a block diagram illustrating a network structure of a vinyl greenhouse management system according to the present invention.

FIG. 2 is a diagram illustrating a structure of a vinyl and a heating film of a vinyl greenhouse illustrated in FIG. 1.

FIG. 3A is a block diagram illustrating a connection structure between sensor terminals and a control device using the heating film of the vinyl greenhouse illustrated in FIG. 1.

FIG. 3B is a block diagram illustrating a connection structure between sensor terminals and a control device using a heating film of a vinyl greenhouse according to another embodiment of the present invention.

FIG. 3C is a block diagram illustrating a connection structure between sensor terminals and a control device using a heating film of a vinyl greenhouse according to yet another embodiment of the present invention.

FIG. 4A is a block diagram illustrating a structure of the sensor terminals illustrated in FIG. 3A or FIG. 3B.

FIG. 4B is a block diagram illustrating a structure of the sensor terminals illustrated in FIG. 3C.

FIG. 5 is a block diagram illustrating a structure of the control device illustrated in FIG. 3A to FIG. 3C.

FIG. 6 is a block diagram illustrating a structure of a vinyl greenhouse management server illustrated in FIG. 1.

FIG. 7 is a flowchart illustrating a process sequence of the vinyl greenhouse management system according to the present invention.

### DETAILED DESCRIPTION OF THE PREFERRED EMBODIMENTS

Embodiments of the present invention can be modified and changed in various ways, and the scope of the present invention should not be construed as being limited to the embodiments described below. The present embodiments are provided in order to more completely explain the present invention to a person having ordinary skill in the art. Therefore, in the drawings, the shapes of components are exaggerated for clarity.

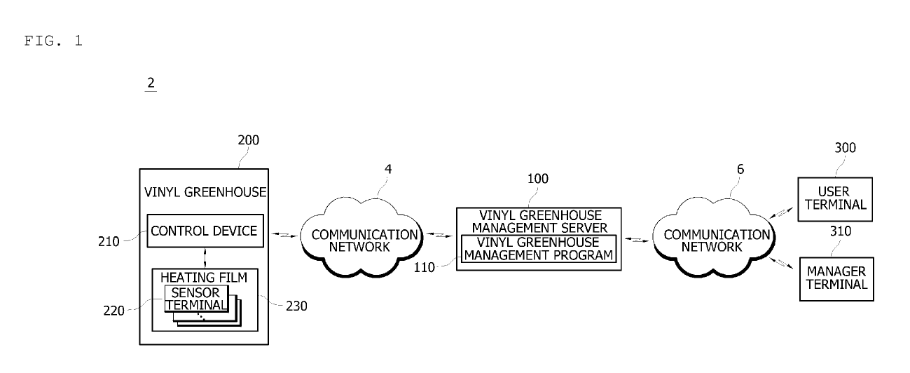

Hereinafter, the embodiments of the present invention will be described in detail with reference to FIG. 1 to FIG. 7.

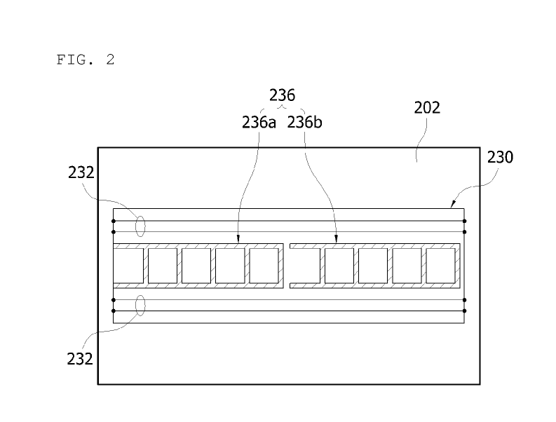

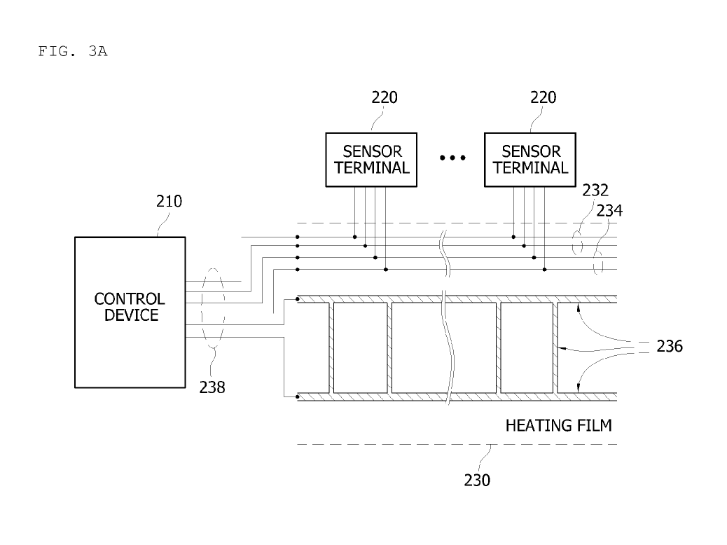

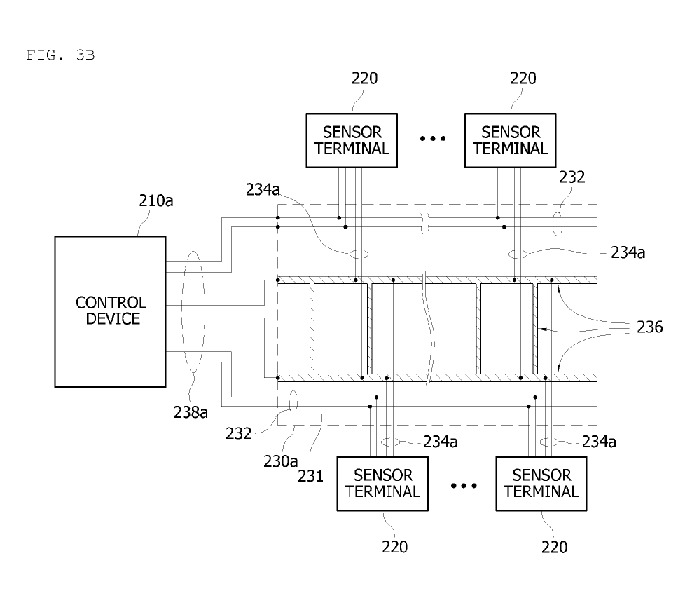

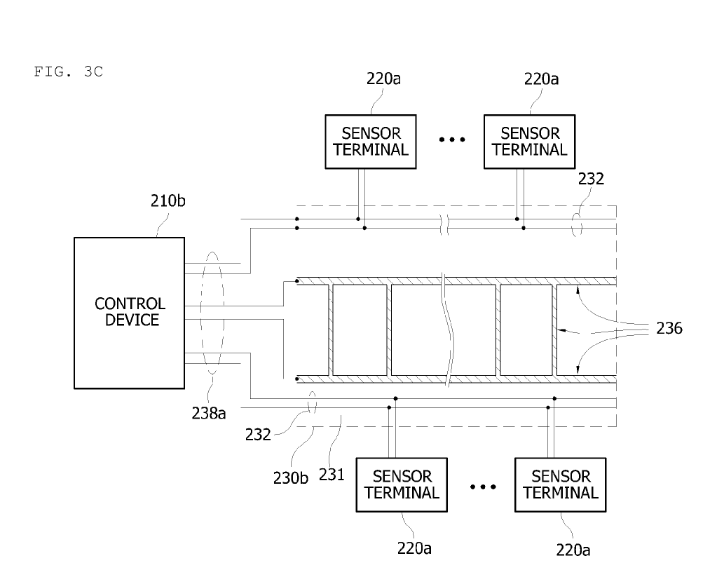

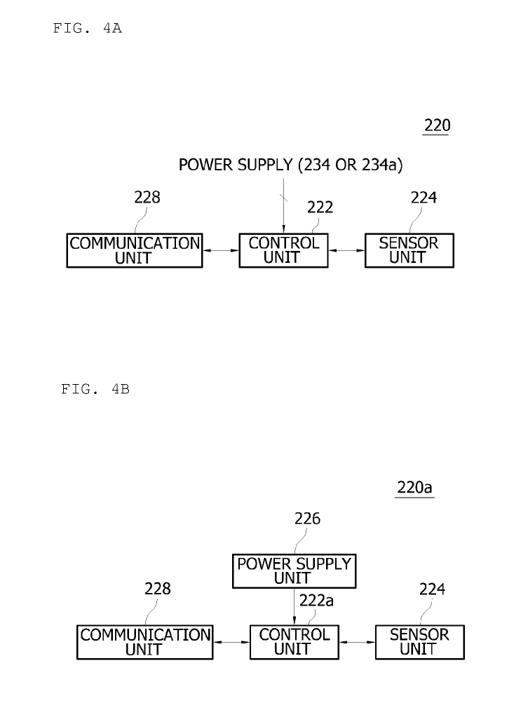

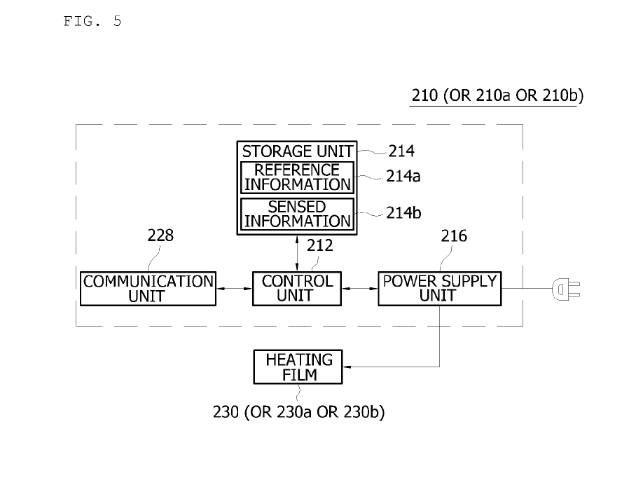

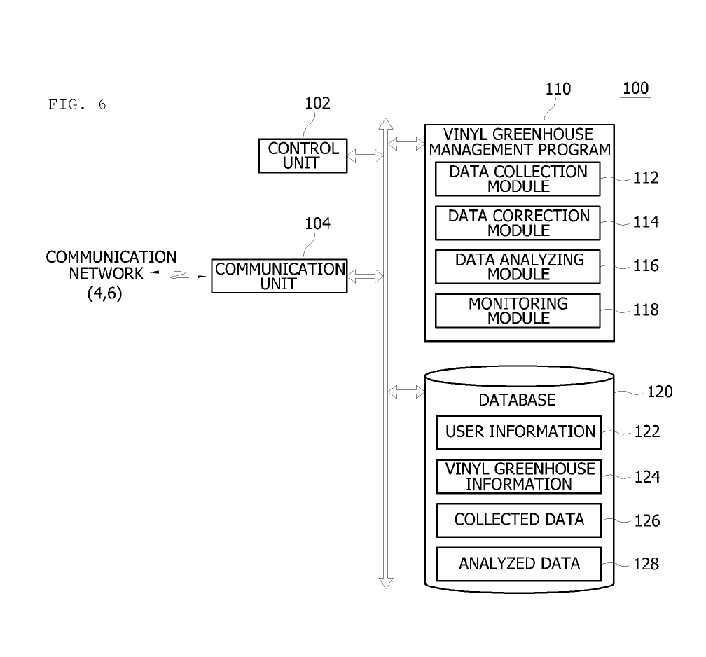

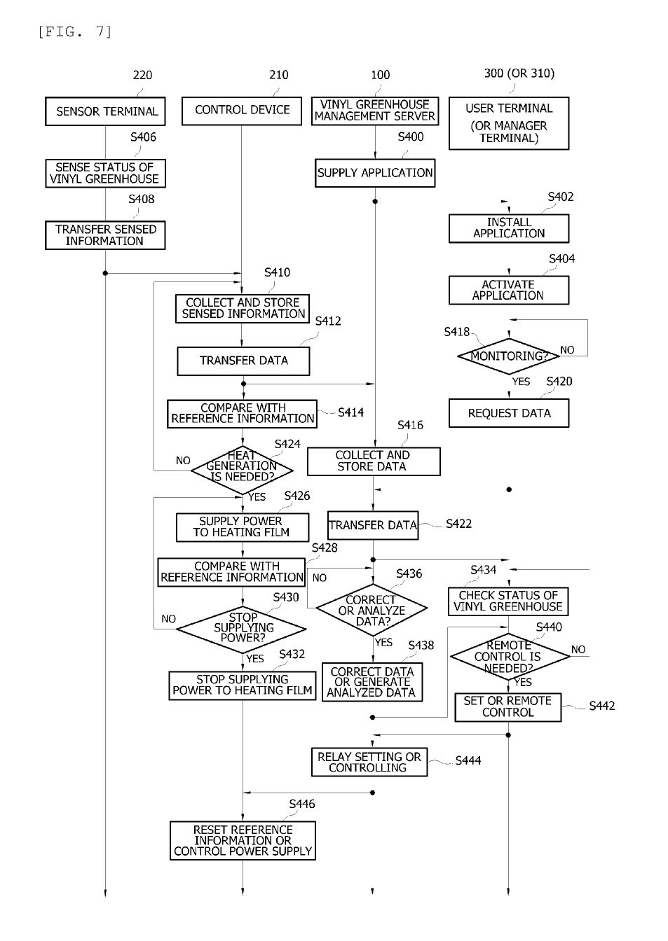

FIG. 1 is a block diagram illustrating a network structure of a vinyl greenhouse management system according to the present invention, FIG. 2 is a diagram illustrating a structure of a vinyl and a heating film of a vinyl greenhouse illustrated in FIG. 1, FIG. 3A to FIG. 3C are block diagrams respectively illustrating connection structures between sensor terminals and a control device using the heating film of the vinyl greenhouse illustrated in FIG. 1 according to different embodiments, FIG. 4A and FIG. 4B are block diagrams respectively illustrating structures of the sensor terminals illustrated in FIG. 3A to FIG. 3C, FIG. 5 is a block diagram illustrating a structure of the control device illustrated in FIG. 3A to FIG. 3C, and FIG. 6 is a block diagram illustrating a structure of a vinyl greenhouse management server illustrated in FIG. 1.

Referring to FIG. 1 to FIG. 6, a vinyl greenhouse management system 2 of the present invention is configured to measure, in real time, various sensed information (for example, a weight of snow accumulated on a vinyl greenhouse 200, a temperature and a wind speed around the vinyl greenhouse 200, an internal brightness of the vinyl greenhouse 200, and the like) about an environmental condition of a vinyl greenhouse 200 built by using a heating film 230 including a plurality of heating patterns (236 of FIG. 2) and a plurality of circuit patterns (232 of FIG. 2), monitor, in real time, a status of the vinyl greenhouse 200, reset reference information, or remotely control to supply power or stop supplying power to the heating patterns 236 by a user terminal 300 and a manager terminal 310 by comparing the sensed information with the reference information through communication networks 4 and 6.

In order to do so, the vinyl greenhouse management system 2 of the present invention includes the communication networks 4 and 6, a plurality of sensor terminals 220 provided at the vinyl greenhouse 200, a control device 210 of the vinyl greenhouse 200, the user terminal 300, and the vinyl greenhouse management server 100. Further, the vinyl greenhouse management system 2 may further include the manager terminal 310.

First, as illustrated in FIG. 2, the vinyl greenhouse 200 includes the heating film 230 provided at a part of vinyl covering a surface of a structure of the vinyl greenhouse (for example, a part of the roof of the vinyl greenhouse) including a frame (not illustrated). The heating film 230 is comprised of a polymer film 231, the plurality of heating patterns 236 (236a, 236b) formed by printing conductive ink on the polymer film 231 by using the printed electronics, and the plurality of circuit patterns 232 for data transfer. Further, as illustrated in FIG. 3A, the heating film 230 may further include a plurality of power supply lines 234 in order to supply a power to the sensor terminals 220.

To be specific, the polymer film 231 of the present embodiment may be formed of a synthetic resin such as a polyethylene (PE) film, a polyester (PET) film, a polyimide (PI) film, a PEN (polyethylene naphthalate) film, a PVC (polyvinyl chloride) film, and a PP (polypropylene) film. Further, conductive ink is printed on one surface of the polymer film 231, so that the plurality of heating patterns 236 electrically connected with each other, and the plurality of circuit patterns 232.

The heating patterns 236 are configured to receive a power from a power supply unit (216 of FIG. 5) of the control device 210 and generate heat. The heating patterns 236 may be disposed in parallel at the same distance or orthogonal to each other, or may be disposed in the form of a cell unit or a metal mesh if necessary, and may be printed in various shapes so as to be connected to each other in series and/or in parallel. Further, the heating patterns 236 may be printed with the same line width, or may be printed with various line widths if necessary. Herein, the plurality of heating patterns 236 is connected to each other in parallel in order to generate heat in a uniform manner. In this case, since the heating patterns 236 are connected to each other in parallel, even if a specific part is damaged, the other parts can be normally operated. Further, as illustrated in FIG. 2, the heating patterns 236 may be divided into a plurality of cell units 236a and 236b in order to facilitate power supply according to a length of the heating film 230. In this case, each of the divided heating patterns 236a and 236b is electrically connected so as to be supplied with a power from the control device 210.

Further, the heating patterns 236 do not include a separate resistant element, and may be formed by printing conductive ink prepared by carbon-based materials such as carbon black, carbon nano tube (CNT), graphene, and carbon fiber, conductive metal powder-based materials such as silver (Ag), nickel (Ni), copper (Cu), and aluminum (Al), or coating particle powder-based materials such as copper (Cu) coated with silver (Ag) or silicon (Si), and a transparent electrode material such as silver nanowire (AgNW), carbon nano tube (CNT), graphene, and a conductive polymer.

Therefore, the heating patterns 236 do not generate heat by using a separate resistant element, but generate heat by using a resistance of the patterns printed with the conductive ink. The heat generated from the heating patterns 236 heats a surface of the heating film 230 and thus may melt snow accumulated on the vinyl greenhouse 200. Herein, the resistance of the heating patterns 236 and an amount of generated heat can be controlled by regulating a line width and a length of the heating patterns 236 and a current applied to the heating patterns 236.

The circuit patterns include a plurality of data transfer lines 232. Further, the circuit patterns may further include a plurality of power supply lines 234. By way of example, the data transfer lines 232 include a plurality of circuit patterns for multiplex communication with the plurality of sensor terminals 220. Further, the power supply lines 234 include two circuit patterns to be supplied with a positive (+) power and a negative (−) power. Furthermore, in the present embodiment, the data transfer lines 232 include two circuit patterns so as to transfer data by using a serial communication network method such as CAN (Controller Area Network) communication. The circuit patterns 232 and 234 are printed with conductive ink identical to or substantially similar to that of the heating patterns 236.

The heating patterns 236 and the circuit patterns 232 and 234 are formed by printing conductive ink on the polymer film 231 by using the printed electronics such as screen printing, gravure printing, and gravure off-set printing.

Accordingly, the heating film 230 applied to the vinyl greenhouse management system 2 of the present invention can be manufactured by a relatively simple process at a lower manufacturing cost as compared with the photolithography process. Further, since only a necessary part of the heating film 230 is printed with the conductive ink, is possible to minimize unnecessary blocking of sunlight required for the growth of crops cultured in the vinyl greenhouse 200. Furthermore, since the heating film 230 is formed by printing the heating patterns 236 directly on the polymer film 231 used for the vinyl greenhouse 200, it is possible to easily manufacture the large-scale vinyl greenhouse 200 and also possible to reduce a manufacturing cost. The heating film 230 can be prepared in various forms depending on a characteristic, such as a shape and a size, of the vinyl greenhouse 200.

Further, the vinyl greenhouse 200 includes the plurality of sensor terminals 220 configured to measure various sensed information about an environmental condition of the vinyl greenhouse 200 and the control device 210 configured to receive the sensed information measured by the sensor terminals 220 and collect and store data and supply the collected data to the vinyl greenhouse management sever 100, and supply power or stop supplying power to the heating film 230 by comparing the sensed information with the reference information.

The sensor terminals 220 are provided at different positions on the vinyl greenhouse 200, and include at least one sensor configured to measure various sensed information about an environmental condition of the vinyl greenhouse 200. For example, the sensor terminals 220 include at least one of a weight sensor (or a pressure sensor) configured to measure a weight of snow accumulated on the vinyl greenhouse 200, a temperature sensor configured to measure a temperature inside and around the vinyl greenhouse 200, a vibration sensor (or a wind speed sensor) configured to measure an air volume around the vinyl greenhouse 200, and a light sensor configured to measure an internal brightness of the vinyl greenhouse 200.

Further, in order to accurately measure the sensed information about the environmental condition of the vinyl greenhouse 200, the plurality of sensor terminals 220 is disposed at appropriate positions inside and outside the vinyl greenhouse 200 and fixed and installed at a frame (not illustrated) of the vinyl greenhouse 200. In order to do so, the sensor terminal 220 includes a coupling unit (not illustrated) for coupling with the frame of the vinyl greenhouse 200. For example, the coupling unit may be provided in various forms or structures for screw coupling, clamp coupling, band coupling, and the like.

The sensor terminals 220 are electrically connected with the control device 210 by using the circuit patterns 232 of the heating film 230 in order to transfer the sensed information.

To be specific, referring to FIG. 3A and FIG. 4A, the sensor terminals 220 of the present embodiment are electrically connected with the circuit patterns 232 and 234 of the heating film 230. That is, the sensor terminals 220 are connected with the power supply lines 234 of the heating film 230 so as to receive a power from the outside and connected with the data transfer lines 232 of the heating film 230 so as to transfer the sensed information to the control device 210. Further, the heating patterns 236 and the circuit patterns 232 and 234 are electrically connected with the control device 210 through a cable 238 including a plurality of wires.

In order to do so, on the heating film 230, the plurality of heating patterns 236, the plurality of power supply lines 234, and the plurality of data transfer lines 232 are formed. Further, the sensor terminal 220 is provided as being modulated, and includes a sensor unit 224, a communication unit 228, and a control unit 222.

The sensor unit 224 includes at least any one of various sensors such as a weight sensor (or a pressure sensor), a temperature sensor, a vibration sensor, and a light sensor. That is, the weight sensor (load cell) is configured to measure a weight of snow accumulated on the vinyl greenhouse 200, the temperature sensor is configured to measure a temperature inside and around the vinyl greenhouse 200, the vibration sensor is configured to measure an air volume (or an intensity of wind) around the vinyl greenhouse 200, and the light sensor is configured to measure an internal brightness of the vinyl greenhouse 200. When snow is accumulated on the vinyl greenhouse 200, it becomes dark inside the vinyl greenhouse 200, and when snow is not accumulated, it becomes bright. Herein, the light sensor is provided to sense such a condition.

The sensor unit 224 is controlled by the control unit 222 so as to measure sensed information about an environmental condition of the vinyl greenhouse 200 in real time. The measured sensed information is transferred by the communication unit 228 to the control device 210 through the data transfer lines 232 of the heating film 230. The communication unit 228 is controlled by the control unit 222 so as to transfer the sensed information measured by the sensor unit 224 to the control device 210.

The control unit 222 controls all the operations of the sensor terminal 220. That is, the control unit 222 controls the sensor unit 224 to measure sensed information about an environmental condition of the vinyl greenhouse 200, and controls the communication unit 228 to transfer the sensed information measured by the sensor unit 224 to the control device 210.

In another embodiment, referring to FIG. 3B and FIG. 4A, the sensor terminal 220 of the present embodiment includes the same components, i.e., the sensor unit 224, the communication unit 228, and the control unit 222, as illustrated in FIG. 3A. Therefore, a detailed description of a configuration of the sensor terminal 220 in the present embodiment will be omitted. However, the sensor terminal 220 of the present embodiment is electrically connected 234a with the heating pattern 236 and receives a power from a control device 210a through the heating pattern 236. In order to do so, on a heating film 230a, the plurality of heating patterns 236 and the plurality of data transfer lines 232 are formed in a different manner from FIG. 3A. Further, the heating patterns 236 and the data transfer lines 232 are electrically connected with the control device 210a through a cable 238a including a plurality of wires.

In yet another embodiment, referring to FIG. 3C and FIG. 4B, a sensor terminal 220a of the present embodiment includes a power supply unit 226 therein and supplies a power from the power supply unit 226. That is, the sensor terminal 220a of the present embodiment is modulated as including the sensor unit 224, the power supply unit 226, the communication unit 228, and the control unit 222. The sensor unit 224, the communication unit 228, and the control unit 222 have functions substantially identical or similar to those of FIG. 4A, and, thus, a detailed description thereof will be omitted herein.

In order to do so, on a heating film 230b, the plurality of heating patterns 236 and the plurality of data transfer lines 232 are formed in a different manner from FIG. 3A. Further, the sensor terminal 220a and a control device 210b are electrically connected with each other through the data transfer lines 232. Furthermore, the heating patterns 236 and the data transfer lines 232 are electrically connected with the control device 210b through the cable 238a including a plurality of wires.

The power supply unit 226 supplies a power required for operating the sensor terminal 220. In the present embodiment, the power supply unit 226 is provided as a primary battery. Otherwise, the power supply unit 226 may be provided as a secondary battery which can be recharged. Herein, the power supply unit 226 is recharged by receiving a power from the outside, for example, the power supply unit (216 of FIG. 5) of the control device 210 or 210a, through the power supply line 234 or the heating pattern 236 of the heating film 230 or 230a. In this case, the control unit 222 further controls power supply and charge/discharge of the power supply unit 226. Also, the power supply unit 226 may be supplied with a power from the other external power supply devices (not illustrated), for example, a photovoltaic power generator, an aerogenerator, and the like.

Further, the control device 210, 210a, or 210b collects sensed information about an environmental condition of the vinyl greenhouse 200 in real time by controlling the sensor terminals 220 and 220a so as to control a status of the vinyl greenhouse 200. That is, the control device 210, 210a, or 210b sets and stores reference information about an environmental condition of the vinyl greenhouse 200, such as a weight of accumulated snow, a temperature, a wind speed, and a brightness, and compares various sensed information measured by the sensor terminals 220 and 220a with the reference information so as to supply power or stop supplying power to the heating film 230, 230a, or 230b. Further, the control device 210, 210a, or 210b supplies various sensed information to the vinyl greenhouse management server 100 through the communication network 4 and controls a status of the vinyl greenhouse 200, i.e., supplies power or stops supplying power to the heating film 230, 230a, or 230b, in response to a remote control of the vinyl greenhouse management server 100.

To be specific, as illustrated in FIG. 5, the control device 210, 210a, or 210b includes a storage unit 214, the power supply unit 216, a communication unit 218, and a control unit 212. The control device 210, 210a, or 210b is provided so as to correspond to the single vinyl greenhouse 200. Otherwise, the control device 210, 210a, or 210b may be provided so as to correspond to a plurality of, for example, two to four vinyl greenhouses 200.

The storage unit 214 stores reference information 214a about each environmental condition, i.e., a weight of accumulated snow, a temperature, a wind speed, and a brightness, of the vinyl greenhouse 200 under the control of the control unit 212. Further, the storage unit 214 stores sensed information 214b measured by the sensor terminal 220 in real time under the control of the control unit 212. Herein, the reference information 214a and the sensed information 214b can be updated under the control of the control unit 212.

The power supply unit 216 receives a power from the outside and supplies the power to the sensor terminals 220 through the power supply line 234 or the heating pattern 236 of the heating film 230, 230a, or 230b. In the present embodiment, the power supply unit 216 may supply a DC or AC power to each of the sensor terminals 220 or charges the power supply unit 226, i.e., the battery, of the sensor terminal 220a.

The communication unit 218 transfers the various sensed information 214b stored in the storage unit 214 to the vinyl greenhouse management server 100 through the communication network 4 and receives information necessary for remote control from the vinyl greenhouse management server 100 and transfers the necessary information to the control unit 212 in order to perform monitoring, remote control, and overall management of at least one vinyl greenhouse 200 under the control of the control unit 212.

The control unit 212 controls all the operations of the control device 210, 210a, or 210b. That is, the control unit 212 stores and manages the various sensed information 214b about the environmental condition of the vinyl greenhouse 200 by controlling the storage unit 214, the power supply unit 216, and the communication unit 218, and sets and stores the reference information 214a. Further, the control unit 212 controls the communication unit 218 to enable mutual data communication with the sensor terminals 220 and 220a and the vinyl greenhouse management server 100. Furthermore, the control unit 212 supplies power or stops supplying power to the heating patterns 236 of the heating film 230 depending on an environmental condition of the vinyl greenhouse 200 by comparing the sensed information with the reference information.

Referring to FIG. 1 again, the communication networks 4 and 6 are configured as a wired/wireless communication network or a mobile communication network, and configured as a single or complex communication network that enables mutual data communication among the control device 210 of at least one vinyl greenhouse 200, the user terminal 300, the manager terminal 310, and the vinyl greenhouse management server 100. In the present embodiment, the control device 210 is connected with the vinyl greenhouse management server 100 via a wire communication network and a wireless communication network such as WiFi, and Bluetooth, and the vinyl greenhouse management server 100 is connected with the user terminal 300 and the manager terminal 310 via a wireless communication network or a mobile communication network such as 3G, and LTE.

Each of the user terminal 300 and the manager terminal 310 is connected with the vinyl greenhouse management server 100 via the communication network 6 so as to monitor or remotely control a status of the vinyl greenhouse 200 in real time, and may be configured as a portable terminal such as a smart phone, a tablet computer, or a notebook computer, and a personal computer. In the present embodiment, each of the user terminal 300 and the manager terminal 310 is configured as a smart phone.

Each of the user terminal 300 and the manager terminal 310 is connected with the vinyl greenhouse management server 100 by using a computer program in the form of a web browser or an application, i.e., an application (not illustrated) for monitoring or remote control of a vinyl greenhouse. Herein, the application may be downloaded from, for example, the vinyl greenhouse management server 100 or an application market, and may be implemented as being linked with a vinyl greenhouse management program 110 of the vinyl greenhouse management server 100.

The user terminal 300 and the manager terminal 310 are connected with the vinyl greenhouse management server 100 by using the application through the communication network 6 and registered as users through user authentication, and receive, in real time, various sensed information about an environmental condition of the vinyl greenhouse 200 from the vinyl greenhouse management server 100 so as to monitor a status of the vinyl greenhouse 200. Further, the user terminal 300 and the manager terminal 310 supply remote control information to the vinyl greenhouse management server 100 by using the application through the communication network 6 in order to remotely control the control device 210 of the vinyl greenhouse 200. Furthermore, the user terminal 300 and the manager terminal 310 may supply each of various sensed information to the control device 210 through the communication networks 4 and 6 so as to set reference information for power supply to the heating patterns 236 of the heating film 230.

Herein, in order for a user and a manager to independently perform monitoring or remote control of a plurality of vinyl greenhouses 200 such as a large-scale farm or an enterprise-type farm, the user terminal 300 and the manager terminal 310 are separately provided. However, if there are a small number of vinyl greenhouses 200, i.e., a user and a manager are one and the same, only any one of the user terminal 300 and the manager terminal 310 may be provided.

Further, the vinyl greenhouse management server 100 is configured to receive various sensed information from the control device 210 of the vinyl greenhouse 200 through the communication network 4 and collect and store data, and correct and analyze the collected data in order to more accurately check a status of the vinyl greenhouse 200. Furthermore, the vinyl greenhouse management server 100 is configured to supply the corrected and analyzed data to the user terminal 300 and the manager terminal 310 through the communication network 6 such that the user terminal 300 and the manager terminal 310 can monitor the vinyl greenhouse 200. Also, the vinyl greenhouse management server 100 is configured to receive remote control information from the user terminal 300 and the manager terminal 310 and transfer the received remote control information to the control device 210 of the vinyl greenhouse 200.

In order to do so, the vinyl greenhouse management server 100 includes the vinyl greenhouse management program 110 for linking the control device 210 with the user terminal 300 and the manager terminal 310 through the communication networks 4 and 6.

To be specific, referring to FIG. 6, the vinyl greenhouse management server 100 of the present embodiment includes a control unit 102, a communication unit 104, a storage unit (not illustrated) configured to store the vinyl greenhouse management program 110, and a database 120. Further, although not illustrated in the drawing, the vinyl greenhouse management server 100 includes components of a typical computer system, such as a central processing unit, a memory device, an input/output device, and a storage device.

The communication unit 104 is connected with the control device 210 of the vinyl greenhouse 200, the user terminal 300 and the manager terminal 310 through the communication networks 4 and 6 under the control of the control unit 102 and configured to enable mutual data communication among the control device 210, the user terminal 300, the manager terminal 310, and the vinyl greenhouse management server 100.

The control unit 102 controls and implements all the operations of the vinyl greenhouse management server 100. Although not illustrated in the drawing, the control unit 102 may include not only hardware such as a central processing unit, a memory, or a web server, but also software such as an operating system program, and a control program.

The control unit 102 is configured to supply various sensed information to the user terminal 300 and the manager terminal 310 by using the vinyl greenhouse management program 110 such that the user terminal 300 and the manager terminal 310 can monitor a status of the vinyl greenhouse 200 in real time, and receive remote control information from the user terminal 300 and the manager terminal 310 and supply the received remote control information to the control device 210 of the vinyl greenhouse 200.

That is, the control unit 102 implements the vinyl greenhouse management program 110 so as to supply an application for monitoring or remote control of a vinyl greenhouse to the user terminal 300 and the manager terminal 310, and enables the user terminal 300 and the manager terminal 310 to be connected with the vinyl greenhouse management server 100 and registered as users through user authentication. The control unit 102 receives, in real time, sensed information measured by the sensor terminals 220 through the control device 210, stores and manages the sensed information in the database 120, and supplies the sensed information to the user terminal 300 and the manager terminal 310 so as to monitor a status of the vinyl greenhouse 200 in real time. Also, if it is necessary to perform remote control while the user terminal 300 and the manager terminal 310 monitors the status of the vinyl greenhouse 200, the control unit 102 receives remote control information from the user terminal 300 and the manager terminal 310 and supplies the remote control information to the control device 210 so as to supply power or stop supplying power to the heating film 230 of the vinyl greenhouse 200. Further, if reference information is reset by the user terminal 300 and the manager terminal 310, the control unit 102 transfers the reset reference information to the control device 210 of the vinyl greenhouse 200. Such an operation of the control unit 102 will be described in detail with reference to FIG. 7.

The vinyl greenhouse management program 110 is stored in the storage unit (not illustrated) of the vinyl greenhouse management server 100 and implemented under the control of the control unit 102 so as to read various information from the database 120 or store various information generated during a process in the database 120. Such a vinyl greenhouse management program 110 is supplied in the form of a web browser and an application and installed in the user terminal 300 and the manager terminal 310.

The vinyl greenhouse management program 110 is implemented as being linked with the control device 210 of the vinyl greenhouse 200, the user terminal 300, and the manager terminal 310 under the control of the control unit 102 so as to monitor or remotely control a status of the vinyl greenhouse 200 in real time.

In the present embodiment, the vinyl greenhouse management program 110 is comprised of a data collection module 112, a data correction module 114, a data analyzing module 116, and a monitoring module 118.

The data collection module 112 is configured to receive various sensed information from the control device 210 of the vinyl greenhouse 200 through the communication network 4 and collect data about an environmental condition of the vinyl greenhouse 200 and store the data in the database 120. The data correction module 114 is configured to correct the collected data by using a correction algorithm such as a Kalman filter in order to obtain accurate sensed information. The data analyzing module 116 is configured to analyze the collected and corrected data and generate analyzed data for various purposes such as to check a damage condition or an operation condition of the vinyl greenhouse 200, to check an occurrence condition of each natural disaster, and to predict damage caused by each natural disaster, and store the analyzed data in the database 120. In the present embodiment, the data analyzing module 116 may be used to reset reference information. Further, the monitoring module 118 is configured to supply the collected, corrected, and analyzed data to the user terminal 300 and the manager terminal 310 through the communication network 6 so as to monitor a status of the vinyl greenhouse 200 in real time. If the user terminal 300 and the manager terminal 310 resets reference information or remotely controls to supply power or stop supplying power to the heating film 230 while monitoring the status of the vinyl greenhouse 200, in response to this, the monitoring module 118 supplies remote control information to the control device 210 of the vinyl greenhouse 200.

Further, the database 120 is configured to store various information generated during the implementation of the vinyl greenhouse management program 110 under the control of the control unit 102. In the present embodiment, the database 120 is provided within the vinyl greenhouse management server 100, but may be provided as a separate database server. In the present embodiment, the database 120 stores user information 122, vinyl greenhouse information 124, collected data 126, and analyzed data 128.

The user information 122 includes personal information of the user and the manager input when the user and the manager of the user terminal 300 and the manager terminal 310 are registered as users in the vinyl greenhouse management server 100. For example, the user information 122 includes IDs, authenticated cellular phone numbers, and passwords of the user and the manager, and vinyl greenhouse information matched to the user and the manager. The vinyl greenhouse information 124 includes various information about the vinyl greenhouse 200 operated or managed by the user terminal 300 and the manager terminal 310. In the present embodiment, the vinyl greenhouse information 124 includes a position, a size, the number of sensor terminals 220 of the vinyl greenhouse 200 matched to the user information, and the number of vinyl greenhouses 200 controlled and managed by the single control device 210. As the collected data 126, data corresponding to sensed information collected by the data collection module 112 and corrected data are stored. The collected data 126 are stored as being matched to each of the vinyl greenhouses 200. Further, as the analyzed data 128, data obtained by analyzing the collected and corrected data through a statistical process are stored. The analyzed data 128 may be used as various statistical or analytical data to check a status of the vinyl greenhouse 200 from the collected data and thus perform overall management of the vinyl greenhouse 200 about a weight of accumulated snow, an ambient temperature, an ambient air volume, and an internal brightness of the vinyl greenhouse 200. Further, the analyzed data 128 may be used to reset reference information so as to optimize a status of the vinyl greenhouse 200 by the vinyl greenhouse management server 100, the user terminal 300 and/or the manager terminal 310.

Therefore, the vinyl greenhouse management server 100 of the present invention uses various sensed information measured by the plurality of sensor terminals 220 to monitor and remotely control a status of the vinyl greenhouse 200 in real time as being linked with the control device 210 of the vinyl greenhouse 200, the user terminal 300, and the manager terminal 310.

Continuously, FIG. 7 is a flowchart illustrating a process sequence of the vinyl greenhouse management system according to the present invention. The process is implemented by the vinyl greenhouse management program 110 of the vinyl greenhouse management server 100 and performed as being linked with the sensor terminals 220 of the vinyl greenhouse 200, the control device 210, the user terminal 300, and the manager terminal 310.

Referring to FIG. 7, in step S400, the vinyl greenhouse management system 2 of the present invention supplies an application to the vinyl greenhouse management server 100 such that the application can be downloaded and installed in the user terminal 300 or the manager terminal 310 through the communication network 6. The application is included in the vinyl greenhouse management program 110 and may be supplied in the form of a web browser and an application. In step S402, the application is downloaded by the user terminal 300 or the manager terminal 310 through the communication network 6 and then installed therein. In step S404, the application is activated.

In step S406, the sensor terminals 220 of the vinyl greenhouse 200 measure various sensed information about an environmental condition of the vinyl greenhouse 200 in real time. In the present embodiment, the sensed information includes a weight of snow accumulated on the vinyl greenhouse 200, a temperature and a wind speed around the vinyl greenhouse 200, and an internal bright of the vinyl greenhouse 200. In step S408, the sensed information is transferred to the circuit patterns of the heating film 230, i.e., to the control device 210 through the data transfer lines 232.

In step S410, the control device 210 collects and stores the sensed information, and in step S412, the control device 210 transfers data corresponding to the sensed information to the vinyl greenhouse management server 100 through the communication network 4. In step S414, the control device 210 compares each of the sensed information with reference information. In step S416, the vinyl greenhouse management server 100 collects the data transferred from the control device 210 and stores the data in the database 120. Herein, if the user terminal 300 or the manager terminal 310 needs to monitor the vinyl greenhouse 200 in step S418, the user terminal 300 or the manager terminal 310 requests data required for monitoring a status of the vinyl greenhouse 200 from the vinyl greenhouse management server 100 in step S420. In response to this request, the vinyl greenhouse management server 100 transfers the data to the user terminal 300 or the manager terminal 310 through the communication network 6 in step S422.

In step S424, if the control device 210 determines that it is necessary to generate heat according to a result of comparison between the sensed information and the reference information, i.e., if the sensed information is higher than a predetermined range, the process proceeds to step S426, so that a power is supplied to the heating patterns 236 of the heating film 230 to generate heat. Herein, for example, if the control device 210 determines that snow falls based on the reference information and the sensed information received from the sensor terminals 220 or if the control device 210 determines that snow cannot thaw immediately but can be accumulated or frozen at a current temperature and a current air volume, a power is supplied to the heating patterns 236 of the heating film 230 of the vinyl greenhouse 200. As a result, the heating patterns 236 generate heat so as to remove the snow accumulated on the vinyl greenhouse 200.

In step S428, the control device 210 compares the sensed information with the reference information while supplying a power to the heating film 230 so as to generate heat. Then, in step S430, if the control device 210 determines that the environmental condition of the vinyl greenhouse 200 does not need heat and thus it is necessary to stop supplying power according to a result of comparison between the sensed information and the reference information, the process proceeds to step S432, so that power supply to the heating film 230 is stopped.

In step S434, the user terminal 300 or the manager terminal 310 receives data from the vinyl greenhouse management server 100 and checks and monitors a status of the vinyl greenhouse 200. if the vinyl greenhouse management server 100 needs to correct or analyze the collected data in step S436, the vinyl greenhouse management server 100 corrects or analyzes the data in step S438 and generates the collected data or analyzed data and then stores the data in the database 120.

In step S440, the user terminal 300 or the manager terminal 310 determines whether or not remote control is needed while monitoring a status of the vinyl greenhouse 200. As a result thereof, if remote control is needed, in step S442, the user terminal 300 or the manager terminal 310 resets the reference information through an interface screen of the application or inputs remote control information, and the user terminal 300 or the manager terminal 310 transfers the reset reference information or the input remote control information to the vinyl greenhouse management server 100 through the communication network 6.

In step S444, the vinyl greenhouse management server 100 relays the reference information or the remote control information transferred from the user terminal 300 or the manager terminal 310 to the control device 210 through the communication network 4 so as to reset the reference information or perform remote control. Then, in step S446, the control device 210 resets and stores the reference information or supplies power or stops supplying power to the heating film 230 in response to the remote control information.

Although there has been described the configuration and the operation of the vinyl greenhouse management system according to the present invention has been illustrated in the detailed description of the invention with reference to the drawings, only the embodiments are provided for explanation, and, thus, various changes and modifications can be made without departing from the scope of the present disclosure.

What is claimed is:

1. A vinyl greenhouse management system comprising:
a heating film formed by printing conductive ink on a polymer film into a plurality of heating patterns and a plurality of data transfer lines by using the printed electronics and provided at a part of vinyl of a vinyl greenhouse;
a plurality of sensor terminals respectively fixed and provided at different positions on a frame of the vinyl greenhouse and electrically connected with the data transfer lines of the heating film so as to measure various sensed information about an environmental condition of the vinyl greenhouse;
a control device configured to receive the sensed information measured by the sensor terminals through the data transfer lines and compare the sensed information with predetermined reference information and control a power to be supplied to the heating pattern when the sensed information is out of a predetermined range;
a vinyl greenhouse management server connected to the control device through a communication network and configured to collect the sensed information from the control device and correct and analyze the sensed information; and
a user terminal configured to receive the sensed information corrected and analyzed by the vinyl greenhouse management server through the communication network and monitor and remotely control a status of the vinyl greenhouse in real time.

2. The vinyl greenhouse management system of claim 1, wherein the sensor terminal includes:
a sensor unit including a sensor configured to measure at least one of a weight of snow accumulated on the vinyl greenhouse, a temperature around the vinyl greenhouse, an air volume around the vinyl greenhouse, and an amount of light within the vinyl greenhouse;
a first storage unit configured to store the sensed information corresponding to the sensor;
a first communication unit connected with the data transfer lines and configured to transfer the sensed information to the control device; and
a first control unit configured to control the sensor unit, the first storage unit, and the first communication unit.

3. The vinyl greenhouse management system of claim 2, wherein the control device includes:
a second storage unit configured to store the reference information about each of a weight of accumulated snow, an ambient temperature, an ambient air volume, and an internal brightness about an environmental condition of the vinyl greenhouse and the sensed information measured by the sensor terminals in real time;
a power supply unit configured to supply a power of the control device and supply a power to the heating patterns of the heating film;
a second communication unit configured to receive the sensed information from the sensor terminals and transfer the sensed information to the vinyl greenhouse management server; and
a second control unit configured to control the second storage unit, the power supply unit, and the second communication unit and compare the sensed information with the reference information so as to supply power or stop supplying power from the power supply unit to the heating patterns.

4. The vinyl greenhouse management system of claim 3, wherein the vinyl greenhouse management server includes:
a third communication unit provided to enable mutual data communication between the control device and the user terminal through the communication network;
a third storage unit interconnected with the control device and the user terminal through the communication network and configured to store a vinyl greenhouse management program for monitoring the status of the vinyl greenhouse in real time and remotely control the power supply to the heating patterns;
a database configured to store at least collected data corresponding to the sensed information and analyzed data generated by analyzing the collected data; and
a third control unit configured to control the third communication unit, the third storage unit, and the database, supply the collected data and the analyzed data to the user terminal through the communication network, and, when remote control information is generated from the user terminal, transfer the remote control information to the control device to implement the vinyl greenhouse management program.

5. A processing method of a vinyl greenhouse management system, comprising:
providing a heating film formed by printing conductive ink on a polymer film into a circuit pattern including a plurality of heating patterns and a plurality of data transfer lines by using the printed electronics at a part of vinyl of a vinyl greenhouse, electrically connecting a plurality of sensor terminals respectively fixed and provided at different positions on the vinyl greenhouse and configured to measure various sensed information about an environmental condition of the vinyl greenhouse with the data transfer lines of the heating film, and comparing the sensed information with predetermined reference information corresponding to the sensed information so as to monitor a status of the vinyl greenhouse and remotely control power supply to the heating film through a user terminal; and
supplying power or stopping supplying power to the heating patterns of the heating film according to a result of the comparison between the sensed information and the reference information.

6. The processing method of claim 5, further comprising:
correcting and analyzing the sensed information so as to enable the user terminal to determine whether or not a remote control is needed while monitoring the status of the vinyl greenhouse and resetting the reference information according to the result of the determination.
